(19) United States
(12) Patent Application Publication
(10) Pub. No.: US 2007/0011499 A1
(43) Pub. Date: Jan. 11, 2007

(54) Methods for ensuring safe component removal

(75) Inventors: Bjorn Bergsten, Southborough, MA (US); Laurent Fournie, Belmont, MA (US); Mark Streitfeld, Arlington, MA (US)

Correspondence Address: KIRKPATRICK & LOCKHART NICHOLSON GRAHAM LLP, One Lincoln Street, BOSTON, MA, 02111-2950, US

(73) Assignee: Stratus Technologies Bermuda Ltd., Hamilton (BM)

(21) Appl. No.: 11/146,864

(22) Filed: Jun. 7, 2005

(51) Int. Cl. G06F 11/00

(52) U.S. Cl. 714/100

(57) ABSTRACT

The invention includes a method for determining whether a node in a non-recursive network can be removed. The method includes the steps of executing a reachability algorithm for a resource of a system upon initialization of the system. The resource is accessible to the system upon the initialization. A safe to pull manager evaluates the reachability algorithm for each node situated on the network to determine whether the node can be removed without interrupting resource accessibility to the system.

### FIELD OF THE INVENTION

The present invention relates generally to fault-tolerance and more specifically to determining whether a node in a network can be safely removed without adversely affecting the remainder of the network.

### BACKGROUND OF THE INVENTION

Fault tolerant systems, by definition, are systems which can survive the failure of one or more components. These failures may happen alone, in an isolated fashion, or together, with one fault triggering a cascade of additional faults among separate components. The faults may be caused by a variety of factors, including software errors, power interruptions, mechanical failures or shocks to the system, electrical shorts, or through user error.

When an individual component fails in a typical computer system, the entire computer system frequently fails. In a fault-tolerant system, however, such system-wide failure must be prevented. Failures must be isolated, to the extent possible, and should be repairable without taking the fault tolerant system offline.

In addition, administrators of fault tolerant systems must have the ability to safely remove interchangeable modules within the system for routine inspection, cleaning, maintenance, and replacement. Ideally, fault tolerant systems would continue operating, even with some modules removed.

### SUMMARY OF THE INVENTION

Towards that end, it would be useful to determine which components are critical to the continued operation of a fault tolerant system, and which components may fail or be removed by administrators without jeopardizing the stability of the entire system. Thus, a need exists for solutions capable of determining whether or not a fault-tolerant system would be adversely affected by the removal or failure of each component within that system.

In satisfaction of that need, the claimed invention provides systems and methods which assess the criticality of each component in a fault-tolerant system and determine whether any individual component may safely fail or be removed, or is safe to pull.

In one aspect, the claimed invention includes a method for determining whether a node in a non-recursive network can be removed. The method includes the steps of executing a reachability algorithm for a resource of a system upon initialization of the system. The resource is accessible to the system upon the initialization. A safe to pull manager evaluates the reachability algorithm for each node situated on the network to determine whether the node can be removed without interrupting resource accessibility to the system.

In one embodiment, the method includes updating the reachability algorithm when the network is updated. The method also includes adding a new node, removing a node, and recognizing a node failure. In yet another embodiment, the method includes signaling when the node can be removed from the network and when the node is unsafe to remove from the network. The signaling can include using a first indicator when a node is unsafe to remove and using a second indicator when a node is safe to remove. The evaluating of whether the node can be removed also includes determining whether the node is a root node and whether a threshold number of parent nodes exist for the node. The evaluating of whether the node can be removed can also include simulating a failure of the node. In one embodiment, the simulating of the failure of the node includes setting a variable in the reachability algorithm that corresponds with the node to a predetermined number.

In another aspect, a network includes a computer system having a safe to pull manager, a resource in communication with the computer system upon initialization of the system, and nodes connected between the resource and the system, wherein the safe to pull manager executes a reachability algorithm for the resource and for each node to determine whether a node can be removed without interrupting resource communication with the system.

In one embodiment, the nodes represent devices. Further, the computer system may execute a program that can access one or more resources. In one embodiment, the determination of whether the node can be removed includes simulating a failure of the node in the reachability expression. In some embodiments, the system is a power grid system. Moreover, the nodes may represent power sinks. In other embodiments, the system is a telephone system and each node represents a telephone transceiver. In some embodiments, the resource includes a disk volume, a network adapter, a physical disk, a program and a network. Further, the node can include a disk mirror, a Small Computer System Interface (SCSI) adapter, a disk, a central processing unit (CPU), an input/output (I/O) board, and a network interface card (NIC).

### BRIEF DESCRIPTION OF THE DRAWINGS

The advantages of the invention described above, together with further advantages, may be better understood by referring to the following description taken in conjunction with the accompanying drawings. In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of a network having a safe to pull manager constructed in accordance with the invention.

FIG. 2 illustrates a directed acyclic graph of a plurality of nodes connecting the root with a plurality of resources.

FIG. 3 is a graphical representation of a RAID system in accordance with one embodiment of the invention.

FIG. 4 illustrates a RAID 5 system with single-initiated disks in accordance with the claimed invention.

FIG. 5 illustrates a RAID 5 system with dual-initiated disks in accordance with the claimed invention.

FIG. 6 is a flow chart of an embodiment of the steps that the safe to pull manager 124 takes to evaluate a system.

FIG. 7 is a flow chart of an embodiment of the steps that the safe to pull manager takes to determine whether or not a node is reachable from the root.

### DETAILED DESCRIPTION OF THE INVENTION

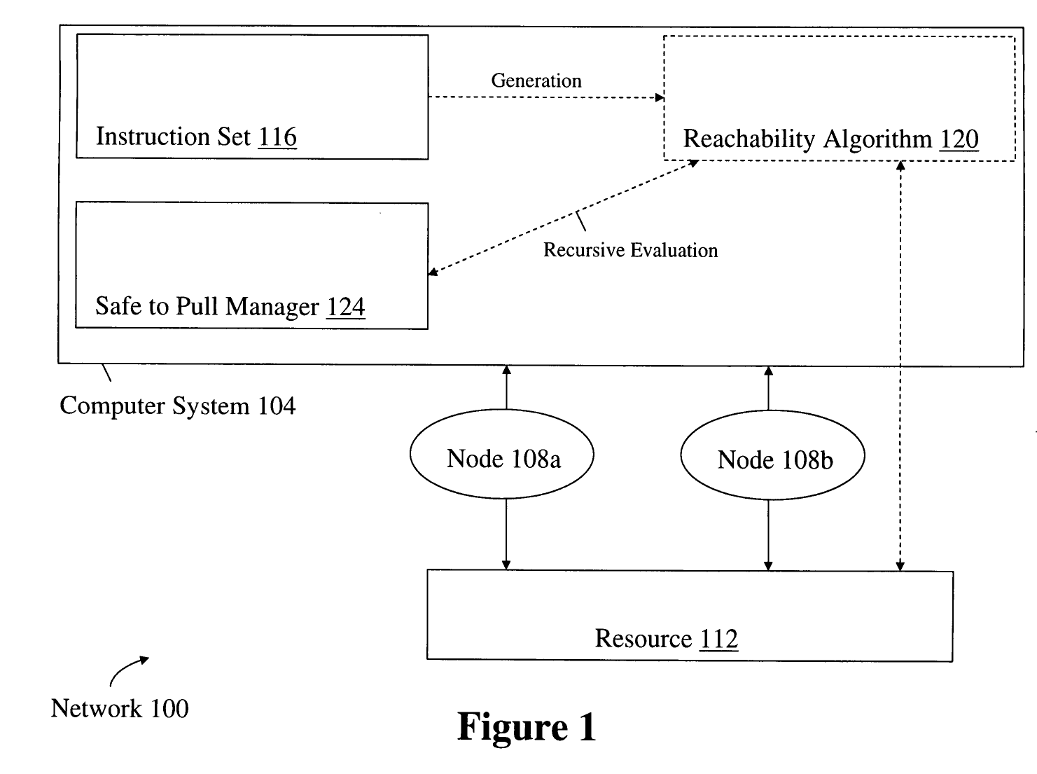

Referring to FIG. 1, a network 100 includes a computer system 104, one or more resources 112, and a plurality of nodes 108a, 108b (each, a node 108). The network 100 is preferably a non-recursive network that does not cycle or loop. The computer system is preferably a fault-tolerant computer system, comprising one or more processors, I/O subsystems, network connections, data storage devices, etc. Each resource 112 comprises a logical entity that is mapped to a physical entity, and often constitutes an abstraction of an external subsystem. For example, the resource 112 may comprise a Redundant Array of Independent Disks, or RAID.

Each node 108 comprises a physical device connecting the computer system 104 to the resource 112. Thus, each node 108 may comprise devices such as an I/O board, a SCSI adapter, or any physical device connecting the computer system 104 to the resource. Although it is shown with only a single computer system 104, the network 100 can have any number of computer systems, each comprising a plurality of resources 112 and nodes 108.

The computer system 104 preferably executes an instruction set 116, such as an application or operating system. At initialization (e.g., boot up) of the system 104, the system verifies that the resource 112 is accessible to the system 104 through the nodes 108. If there are multiple paths between the computer system 104 and the resource 112, then some nodes 108 may be considered safe to pull. A node 108 will be deemed safe to pull if it can fail, be disconnected, or be removed without disconnecting the resource 112 from the computer system 104. Conversely, if a node 108 is required for continued operation of the network 100 and connectivity between the computer system 104 and the resource 112, then it will be deemed unsafe to pull or remove from the network 100.

In one embodiment, one or more of the nodes 108 represent the physical devices of the resource 112. Examples of various nodes 108 include a disk mirror, a Small Computer System Interface (SCSI) adapter, a disk, a central processing unit (CPU), an input/output (I/O) board, and/or a network interface card (NIC). The node 108 can represent a software and/or a hardware device.

Thus, the resource 112 can be a disk volume organized in a RAID5 implemented on a set of physical disks (i.e., nodes 108) so that a single disk failure does not prevent the computer system's access to the volume 108. The resource 112 can also be a physical disk that can be accessed via two adapters (dual initiated disks) (i.e., two nodes 108) so that even if one adapter (112) fails, the disk (108) can be accessed by the other adapter (112). In another embodiment, the processing capability of the computer system 104 can be supported by two CPUs executing in lock-step so that if one CPU fails, the other CPU continues the processing transparently.

Preferably, a safe to pull manager 124 generates a reachability expression (determined through the use of a reachability algorithm) 120 during initialization of the computer system 104 The safe to pull manager 124 recursively evaluates the reachability algorithm 120 to determine whether each node 108 can be removed without interrupting or eliminating the availability of the resource 112 to the system 104, to determine whether the node 108 is safe to pull.

A node 108 may be reachable in one of two ways. First, if the node 108 is part of the programs executing on the computer system 104, the node 108 is deemed reachable. Alternatively, if one or more of a node's parents are deemed reachable, the node 108 is deemed reachable. For example and as described in more detail below, a dual initiated disk 108 requires a single parent to be reachable. A plex, or one mirror of a disk volume, organized in RAID5 on five disks requires four parents to be reachable. The number of parents that a node 108 needs to be reachable in order for the node 108 itself to be reachable is referred to below as the threshold number. The threshold number may be stored in a property of the node 108 or resource. The safe to pull manager 124 can set the threshold number to zero for a resource 112 to ignore the resource 112, as there are always zero or more parents to a given node 108 or resource.

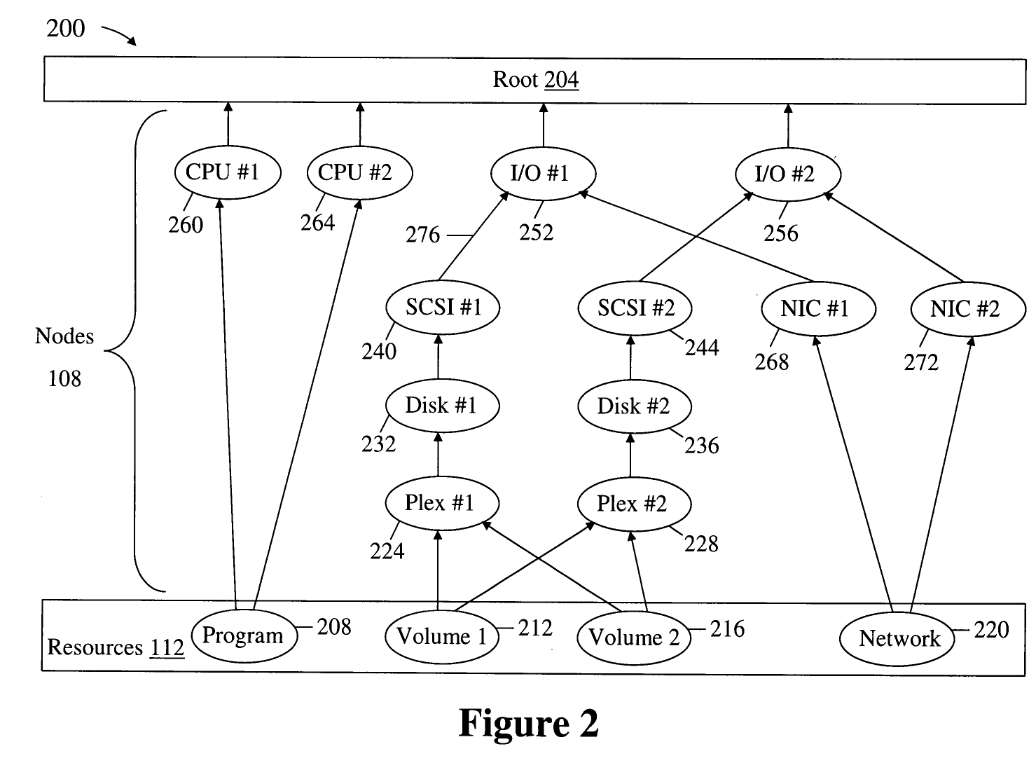

FIG. 2 illustrates a directed acyclic graph 200 of a plurality of nodes 108 connecting the root 204 with a plurality of resources 112. The root 204 represents the set of programs executing on the computer system 104. The resources 112 include a program 208, a first volume 212, a second volume 216, and a network 220. The nodes 108 include a first plex 224, a second plex 228, a first disk 232, a second disk 236, a first SCSI adapter 240, a second SCSI adapter 244, a first I/O board 252, a second I/O board 256, a first CPU 260, a second CPU 264, a first NIC 268, and a second NIC 272.

As illustrated, the program resource 208 needs either the first CPU 260 or the second CPU 264 to be operational in order to be reachable by the root 204. Similarly, the first volume 212 needs either the first plex 224 or the second plex 228 to be operational to be reachable. The first plex 224 requires the first disk 232 to be operational, and the first disk 232 needs the first SCSI adapter 240 to be operational. Arrows, such as a first arrow 276, illustrate the remaining dependencies of the resources 112 and nodes 108.

In this graph 200, when the devices associated with the nodes 108 are online, all devices are safe to pull. For example, the first disk 232 can be removed because all of its resources 112 (i.e., the first volume 212 and the second volume 216) have another path to the root 204 (via the second plex 228, the second disk 236, the second SCSI adapter 244, and the second I/O board 256). If the first disk 232 fails or is removed, then all of the devices represented by the path of the second plex 228, the second disk 236, the second SCSI adapter 244, and the second I/O board 256 become unsafe to pull or remove because if one of these devices fails, the first volume 212 and the second volume 216 are no longer reachable by the root 204.

As described above, the safe to pull manager 124 preferably generates a reachability algorithm 120 having variables that represent the nodes 108 in the graph 200. Each variable takes a value of 1 if the node 108 is not broken (e.g., has not failed or has not been removed) and takes a value of 0 if the node 108 is broken (e.g., failed or has been removed). The value is independent from the states of the other nodes 108.

A reachability expression R can be defined recursively as follows:
1) R(N) evaluates to 0 (i.e., the node N is not reachable) or 1 (i.e., the node N is reachable).
2) When N is the root 204, R(N)=1.
3) A node, identified by its variable N, is connected to n nodes, defined by their variables Ni, with a required minimum number of parents set to T has the following expression: R(N)=N*(R(N1)+ . . . +R(Nn): T. In this expression, “N” takes the value 1 when N is online, 0 otherwise.

The required minimum number of parents T is the threshold number described above. The expression “(A+B+ . . . ): T” evaluates to 1 if and only if “A+B+ . . . ” is larger or equal to T. Thus, the following applies:
1) “(A+B+ . . . ):0” evaluates always to 1
2) “(A):1 evaluates always to A
3) “(R(N)): 1” evaluates always to R(N)
4) “(A1, A2 . . . An): m” evaluates always to 0 when n<m.

To test whether a node 108 is safe to pull for a given resource 112, the safe to pull manager 124 sets the corresponding variable to 0 and evaluates the reachability algorithm. The safe to pull manager 124 sets a variable to 0 to simulate a device pull or failure. If the reachability expression returns a value of 1, the node 108 is safe to pull for the given resource 112. The device is safe to pull if the reachability expression returns, for all resources 112, a value of 1 when the variable representing the corresponding node 108 is zero.

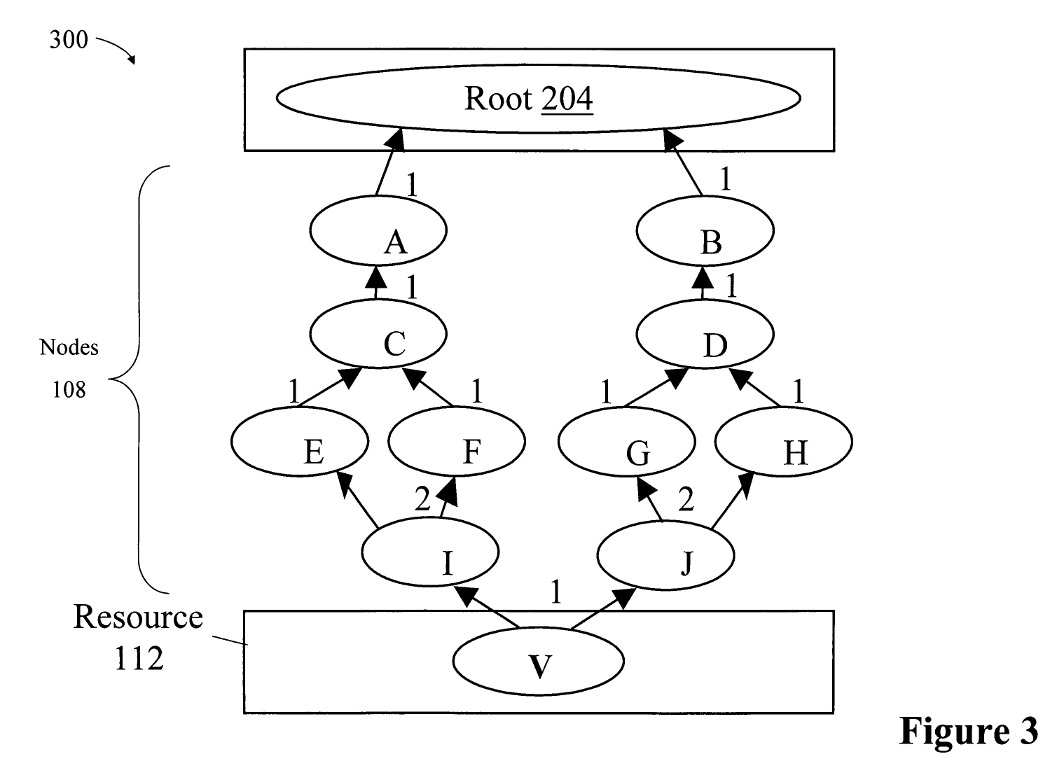

Referring to FIG. 3, a graphical representation 300 of a RAID 10 system is shown. The nodes 108 are labeled with a letter (e.g., “E”) that represents the node 108 in the reachability algorithm. Each node 108 also has a number (e.g., “2”) associated with the node 108. The number indicates the threshold, or minimum number of parents required to be operational. In the illustrated embodiment, V represents a volume resource, I and J are plexes, E, F, G, and H are disks, C and D represent SCSI adapters, and A and B represent I/O boards.

As shown, each disk node G, H has a single parent node DJ. The resource V has a threshold of 1 because it is replicated on two mirrored plexes and is operational as long as one of its parents is operational. Each plex I and J have a threshold of 2 because they are each stored on two disks in striping mode. If one disk is lost, the entire plex is lost. The other nodes 108 have a threshold of 1.

Thus, the safe to pull manager 124 generates a reachability expression for the volume V. Specifically, this reachability expression is R(V)=V(R(I)+R(J)):1. This can be expanded as follows:
1) R(V)=V(R(I)+R(J)):1
2) R(V)=V(I(R(E)+R(F)):2+J(R(G)+R(H)):2):1
3) R(V)=V(I(E(R(C)):1+F(R(C)):1):2+J(G(R(D)): 1+H(R(D)):1):2):1
   Since (R(X)):1 is always equal to R(X), the equation above can be simplified to:
4) R(V)=V(I(E(R(C)+F R(C)):2+J(G(R(D)+H(R(D)):2):1
5) R(V)=V(I(EC(R(A)):1+FC(R(A)):1):2+J(GD(R(B)):1+HD(R(B)):1):2):1 which simplifies to:
6) R(V)=V(I(ECR(A))+FCR(A)):2+J(GDR(B)+HDR(B)):2):1
   Because A and B are directly connected to the root 204, R(A)=A and R(B)=B. Thus:
7) R(V)=V(I(ECA+FCA):2+J(GDB+HDB):2):1
   Because V is a resource, V=1:
8) R(V)=(I(ECA+FCA):2+J(GDB+HDB):2):1
   Finally, because I and J are logical nodes, they are always 1.
9) R(V)=(I(ECA+FCA):2+J(GDB+HDB):2):1
   By factoring “C A” in the first sub-expression and “D B” in the second sub-expression we get:
10) R(V)=(CA(E+F):2+DB (G+H)):2):1
   When all variables are 1, R(V)=1. The system is operational and all resources are reachable.

Furthermore, the expression also evaluates to 1 even when any single device fails. This can be tested by setting any single variable to 0 and evaluating the expression. Therefore, the system is fault-tolerant, or may continue running even with at least one point of failure. The expression can also evaluate how the RAID 10 system behaves with two or more points of failure. For example, if both nodes C and B fail, the resource V is no longer reachable. If, however, G and H fail, the resource V is still reachable.

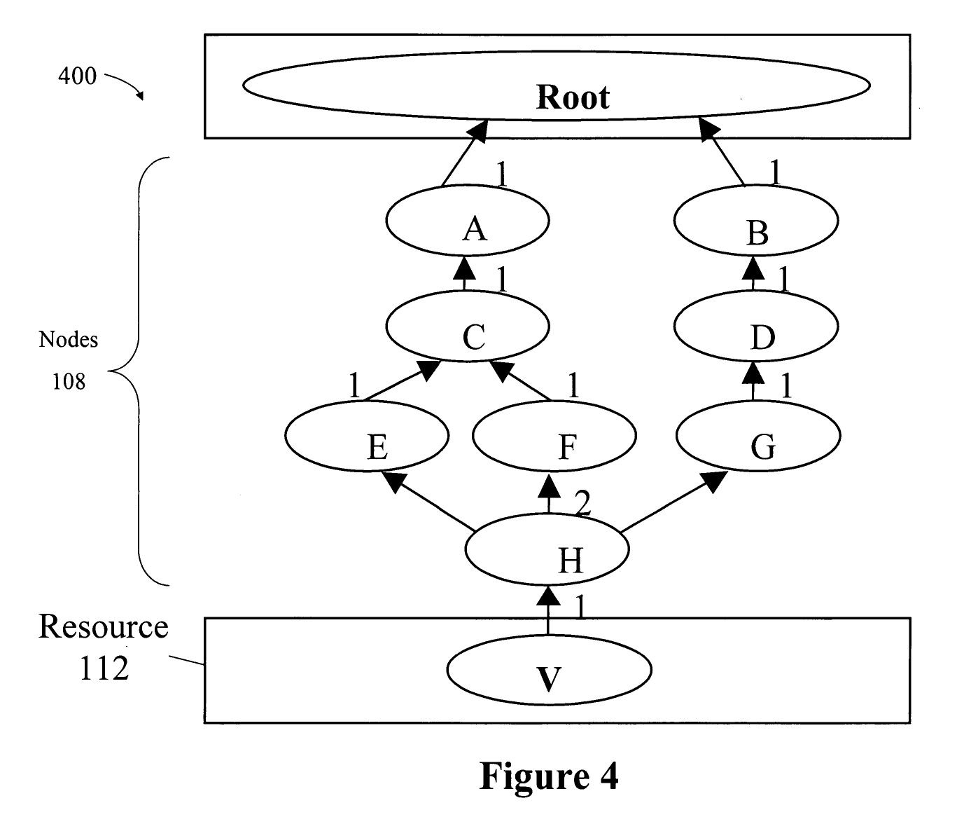

Referring to FIG. 4, a graphical representation 400 of a RAID 5 system with single-initiated disks is shown. The minimum number of parents required for the plex H is 2 because a RAID 5 system implements redundancy in a manner such that the system can loose any single disk. Thus, for the system shown in graphical representation 400, the safe to pull manager 124 builds a reachability algorithm as follows:
1) R(V)=R(H)
2) R(V)=H(R(E)+R(F)+R(G)):2
3) R(V)=(ER(C)+F R(C)+G R(D)):2
4) R(V)=(ECR(A)+FCR(A)+GDR(B)):2
5) R(V)=(ECA+FCA+GDB):2
6) R(V)=(CA(E+F)+GDB):2

When all nodes are online, all corresponding variables are 1 and the expression evaluates to 1. This means that the resource V is reachable. If, however, A or C is 0, R(V)=0. This means that the physical devices corresponding to the nodes A and C are not safe to pull. Thus, the safe to pull manager 124 uses the reachability expression to illustrate that a RAID 5 system does not work well with single initiated disks.

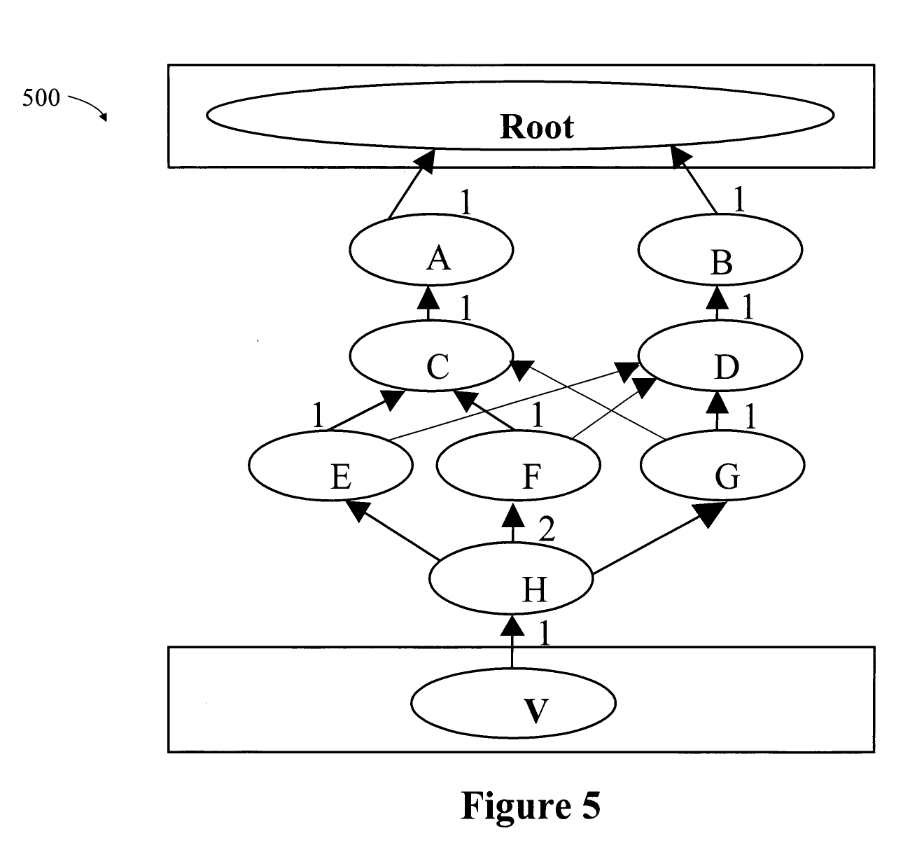

FIG. 5 is a graphical representation 500 of an embodiment of a RAID 5 system with dual-initiated disks. As illustrated, V represents a volume resource implemented through a single plex H that is organized into a RAID 5 on three disks E, F, and G. In one embodiment, the disks E, F, and G are connected to two SCSCI adapters on different I/O boards. Thus, for the illustrated system, the safe to pull manager 124 builds a reachability algorithm as follows:
1) R(V)=R(H)
2) R(V)=H(R(E)+R(F)+R(G)):2
3) R(V)=(E(R(C)+R(D)):1+F(R(C)+R(D)):1+G(R(C)+R(D)):1):2
4) R(V)=(E+F+G):2(R(C)+R(D)):1
5) R(V)=(E+F+G):2(CA+DB):1

When the nodes 108 are present and not broken, all corresponding variables are 1, and the reachability expression evaluates to 1. Thus, the resource V is reachable. Moreover, a single point of failure is also covered. Thus, all devices are safe to pull. Further, in order to continue operating, the following pairs of devices must never fail together: (E, F), (E, G), (F, G), (C, D), (A, B), (C, B), (A, D). Thus, RAID 5 systems work well with dual-initiated disks.

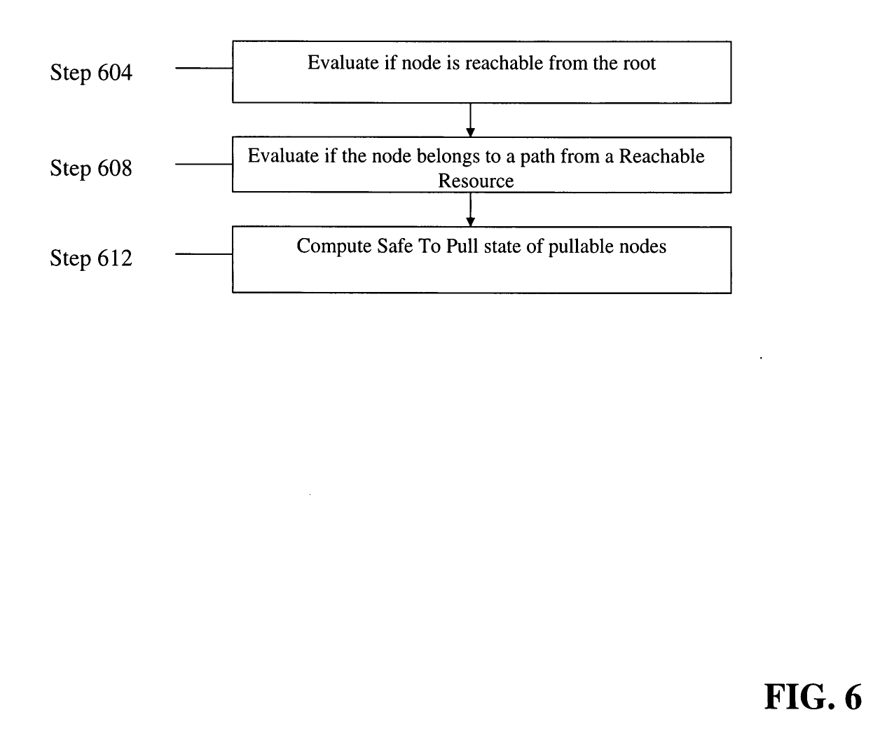

Referring to FIG. 6, the steps that the safe to pull manager 124 takes to evaluate a system are shown. In particular and as described in more detail below, the safe to pull manager 124 evaluates if a node 108 is reachable from the root 204 (step 604). The safe to pull manager 124 then evaluates whether the node 108 belongs to a path from a reachable resource 112 (step 608). Next, the safe to pull manager 124 determines the state of all nodes 108 that are removable (step 612). The safe to pull manager 124 determines this by simulating a failure on the node 108.

In more detail, each node 108 contains the following Boolean variables:

| | |
|---|---|
| Name of Variable | Description |

The following variables describe the state of the node before the STP computation.

| | |
|---|---|
| IsResource | Indicates whether the node is a Resource or a device |
| | node. |
| IsPullable | Indicates whether the STP computation should |
| | evaluate the STP state of this node. |
| IsOnline | Indicates whether the node is ONLINE or |
| | BROKEN. |

The following variables are re-evaluated for each STP computation.

| | |
|---|---|
| IsEvaluated | This Boolean is used to avoid evaluating whether a |
| | node can be reached from the Root more than once. |
| | After having evaluated a node, isEvaluated is set to |
| | true. |
| [isEvaluated==true] isReachable | Indicates whether the node is reachable from the |
| | Root. |
| IsTouched | Indicates whether the node can be reached from a |
| | Resource node that is not broken (i.e., |
| | “isReachable==true”). |
| IsSTP | Specifies whether the node is STP or USTP. It is |
| | only evaluated when isTouched and isOnline and |
| | isEvaluated are true. |

The following variables are re-evaluated for each “Pullable” node
for which the STP state has to be computed.

| | |
|---|---|
| IsOnline | Used to simulate a broken or pulled node. |
| IsSimuEvaluated | It is used to test whether a specific node is STP. |
| | Using this variable avoids evaluating whether this |
| | node can be reached from the Root more than once. |
| | After having evaluated this node, isSimuEvaluated |
| | is set to true. |
| [isSimuEvaluated==true] isSimuReachable | Indicates whether the node can be reached from the |
| | Root, when a specific node is tested. |

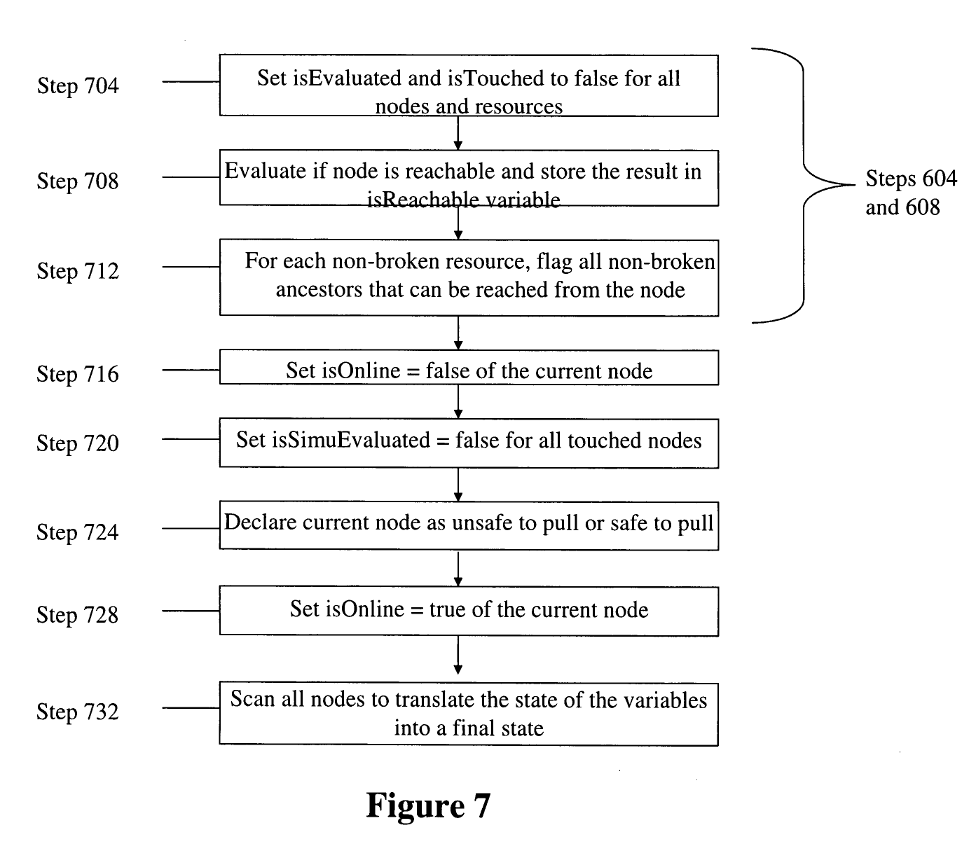

In one embodiment, the safe to pull manager's determination of whether a node 108 is reachable from the root 204 (step 604) and the determination of whether the node 108 belongs to a path from a reachable resource 112 (step 608) is accomplished in three steps. In particular and also referring to FIG. 7, the safe to pull manager 124 sets isEvaluated and isTouched to false for all nodes 108 and resources 112 (step 704). The safe to pull manager 124 then evaluates if a non-broken node 108 is reachable and stores the result in the isReachable variable (step 708). Further, the safe to pull manager 124 also sets the isEvaluated variable to true. For each non-broken resource 112 the safe to pull manager 124 then flags the non-broken ancestors that can be reached from that node 108 (step 712). The safe to pull manager 124 stores the result in the isTouched boolean variable.

The safe to pull manager's computation of the safe to pull state of pullable nodes 108, as described above in step 612 of FIG. 6, is accomplished in four steps. In particular (and still referring to FIG. 7), the safe to pull manager 124 simulates a failure on the node 108. This is done in steps 716-720. The safe to pull manager 124 sets the isOnline variable of the current node 108 to false (step 716) and sets the isSimuEvaluated to false for all touched nodes (Step 720). The safe to pull manager 124 then declares the node 108 as either safe to pull or unsafe to pull (step 724). In one embodiment, the safe to pull manager 124 executes a recursive algorithm moving from the resources 112 to their parents, and from the parents to their parents. In one embodiment, the isSimuEvaluated and isSimuReachable variables are used to avoid re-evaluating the reachability of nodes more than once. The safe to pull manager 124 then sets the isOnline variable of the current node 108 to true (step 728). The safe to pull manager 124 then scans the nodes 108 to translate the state of these working variables into a final safe to pull state (step 732). The table below illustrates how this translation is accomplished (a dash entry means not meaningful):

| IsResource | isOnline | IsReachable | isTouched | isSTP | STP State |
|---|---|---|---|---|---|
| True | — | True | — | — | RESOURCE_ALIVE |
| True | — | False | — | — | RESOURCE_BROKEN |
| False | True | True | True | True | STP |
| False | True | True | True | False | USTP |
| False | True | True | False | — | ONLINE |
| False | True | False | — | — | DISCONNECTED |
| False | False | — | — | — | BROKEN |

Although shown with a single computer system 104, the network 100 can have any number of computer systems.

It will be appreciated, by those skilled in the art, that various omissions, additions and modifications may be made to the methods and systems described above without departing from the scope of the invention. All such modifications and changes are intended to fall within the scope of the invention as illustrated by the appended claims.

We claim:

1. A method for determining whether a node in a plurality of nodes in a network can be removed comprising:
(a) executing a reachability algorithm for a resource of a system upon initialization of the system, wherein the resource is accessible to the system upon the initialization; and
(b) evaluating, by a safe to pull manager and for each node of the plurality of nodes situated on the network between the resource and the system, the reachability algorithm to determine whether the node can be removed without interrupting resource accessibility to the system.

2. The method of claim 1 further comprising updating the reachability algorithm when the network is updated.

3. The method of claim 2 wherein the updating of the network further comprises at least one of adding a new node, removing a node, and recognizing a node failure.

4. The method of claim 1 further comprising signaling when at least one of the node can be removed from the network and when the node is unsafe to remove from the network.

5. The method of claim 4 wherein the signaling further comprises using a first indicator when a node is unsafe to remove and using a second indicator when a node is safe to remove.

6. The method of claim 1 wherein the step of evaluating of whether the node can be removed comprises determining at least one of whether the node is a root node and whether a threshold number of parent nodes exists for the node.

7. The method of claim 1 wherein the evaluating of whether the node can be removed comprises simulating a failure of the node.

8. The method of claim 7 wherein the simulating of the failure of the node comprises setting a variable in the reachability algorithm that corresponds with the node to a predetermined threshold or number.

9. A network comprising:
(a) a computer system comprising a safe to pull manager;
(b) a resource in communication with the computer system upon initialization of the system; and
(c) a plurality of nodes connected between the resource and the system, wherein the safe to pull manager executes a reachability algorithm for the resource and for each node in the plurality of nodes to determine whether a node can be removed without interrupting resource communication with the system.

10. The network of claim 9 wherein the plurality of nodes represent devices.

11. The network of claim 9 wherein the computer system executes a program that can access the resource.

12. The network of claim 9 wherein the determination of whether the node can be removed further comprises simulating a failure of the node in the reachability expression.

13. The network of claim 9 wherein each node in the plurality of nodes is a computer node.

14. The network of claim 9 wherein the system is a power grid system.

15. The network of claim 14 wherein the plurality of nodes represent a plurality of power sinks.

16. The network of claim 9 wherein the system is a telephone system.

17. The network of claim 16 wherein the plurality of nodes represent a plurality of telephone transceivers.

18. The network of claim 9 wherein the resource further comprises at least one of a disk volume, a network adapter, a physical disk, a program, and a network.

19. The network of claim 9 wherein the node further comprises a disk mirror, a SCSI adapter, a disk, a central processing unit, an input/output board, and a network interface card.
